(19) United States
(12) Patent Application Publication
(10) Pub. No.: US 2006/0009197 A1
(43) Pub. Date: Jan. 12, 2006

(54) Call setting method for packet exchange network

(75) Inventors: Tsunehiko Chiba, Saitama (JP); Hiroyuki Shinbo, Saitama (JP); Hidetoshi Yokota, Saitama (JP); Akira Idoue, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/168,930

(22) Filed: Jun. 29, 2005

(30) Foreign Application Priority Data
Jun. 30, 2004 (JP) 2004-194376

(51) Int. Cl. H04M 1/66

(52) U.S. Cl. 455/411

(57) ABSTRACT

The steps and the data amount are reduced by using a PPP non-standard message to shorten a time needed for call setting, and even when a terminal or PDSN is not adapted to the non-standard message, a call setting procedure can be continued according to a PPP standard procedure. The procedure contains the steps of: establishing a wireless link between MS and PDSN, transmitting PPP standard LCP Cfg-Request from PDSN to MS, transmitting PPP non-standard AltPPP Cfg-Request from PDSN to MS, responding to AltPPP Cfg-Request and returning non-standard AltPPP Cfg-Response if MS is adapted to the non-standard message while responding to LCP Cfg-Request and returning standard LCP Cfg-Response if MS is not adapted to the non-standard message, and authenticating MS on the basis of the standard or non-standard Cfg-Response by PDSN.

### BACKGROUND OF THE INVENTION

1. Field of the Invention

The present invention relates to a call setting method for carrying out call setting of a package exchange network in a short time according to a procedure conformable to PPP (Point to Point Protocol).

2. Description of the Related Art

TCP (Transmission Control Protocol) has been popular as a transport layer protocol for connection to the Internet. When a terminal is connected to the Internet through a public network, PPP (Point to Point Protocol) is used as a data link layer protocol serving as a lower layer of TCP/IP (TCP/Internet Protocol). PPP is also adopted for call setting of data communications in Standard System cdma 2000 of third-generation cellular phones.

As shown in FIG. 18, according to the cdma 2000 which is being standardized in 3GPP2 (3rd Generation Partnership Project 2), abase station, a BS controller, PCF (Packet Control Function), PDSN (Packer Data Serving Node) and an AAA (Authentication, Authorization and Accounting) server are connected to the network side to implement IP data communications. AT (Access Terminal) and TE (Terminal Equipment) are set up at the wireless MS (wireless mobile station) of the user side. TE represents an information terminal such as a personal computer or the like, and AT represents a wireless access terminal.

BS establishes a wireless channel with AT. The BS controller controls BS. PCF controls the data communications between the BS controller and PDSN. PDSN connects a wireless access network and an IP network and terminates a logical link. PPP connection is a data communication path established between TE and PDSN. R-P connection is a data communication path established between PCF and PDSN when the PPP connection is established. The R-P connection is established every PPP connection, and a unique identifier is allocated to the R-P connection.

FIG. 19 is a diagram showing a sequence in the case of adoption of CHAP (Challenge Handshake Authentication Protocol) when authentication is made in a Simple IP (SIP) call defined in the cdma 2000. CHAP is a security function supported on the line, and PPP encapsulation is used to prevent an unauthorized access.

Procedure (a): Wireless channel is established between MS and RAN (Radio Access Network).

Procedure (b): Individual R-P connection is established between PCF and PDSN.

Procedure (c): BS requests CHAP-based authentication to PDSN.

Procedure (d): PDSN requests CHAP-based authentication to MS, and PDSN transmits receivable maximum packet size MRU, whereby a wireless channel is established between MS and RAN.

Procedure (e): CHAP-based authentication is acknowledged in PDSN.

Procedure (f): CHAP-based authentication and MRU of PDSN are acknowledged in MS.

Procedure (g): Challenge message for CHAP authentication is transmitted from PDSN to MS.

Procedure (h): Challenge response is generated by MS and transmitted to PDSN together with user name (Username).

Procedure (i): The username, CHAP challenge and CHAP response are transmitted from PDSN to AAA server by using authentication protocol.

Procedure (j): Authentication result (success or failure) and, as occasion demands, IP address “y” used by MS, are transmitted from AAA server to PDSN by using authentication protocol.

Procedure (k): Authentication result is transmitted from PDSN to MS.

Procedure (l) When authentication succeeds, PDSN requests use of “x” as its own IP address to MS.

Procedure (m): MS to which no address is allocated requests use of “0.0.0.0” as its own IP address to PDSN.

Procedure (n): PDSN requests use of “y” of IP address to MS.

Procedure (o): It is acknowledged in MS that PDSN uses “x” as its own IP address.

Procedure (p): MS requests use of “y” as its own IP address to PDSN.

Procedure (q): It is acknowledged in PDSN that MS uses IP address “y.” Thereafter, when MS requests the address of DNS server or the like, a proper response is made to the request.

Procedure (r): PDSN requests start of charging to authentication server.

Procedure (s): Authentication server acknowledges start of charging to PDSN.
[Non-patent Document 1] Simpson, “The Point to Point Protocol (PPP),” RFC 1661, Jul. 1994.
[Non-patent Document 2] P.R0001, “Wireless IP Network Architecture based on IETF Protocols,” 3GPP2, Jul. 2000.
[Non-patent Document 3] P.S0001-A Version 3.0.0, “Wireless IP Network Standard,” 3GPP2, Jul. 2001.
[Non-patent Document 4] Simpson, “PPP Challenge Handshake Authentication Protocol (CHAP),” RFC 1994, Aug. 1996.
[Non-patent Document 5] A.S0007-0 version 1.0, “1×EV-DO Inter-Operability Specification (IOS) for CDMA 2000 Access Network Interfaces,” 3GPP2, Jul. 2001.

PPP is a protocol for dial up connection using modems, and parameters and sequences which are not necessarily used exist in the cdma 2000. Accordingly, the efficiency would be lowered if these are directly used for call setting in data communications of a packet exchange network.

For example, in a sequence (FIG. 19) using CHAP in SIP call, a request/response message for authentication of PDSN by MS is exchanged in the procedures (c) and (e). However, it is not actually carried out and thus it is redundant. After MS transmits the IP address “0.0.0.0” in the procedure (m), the address to be used by MS is transmitted from PDSN in the procedure (n). However, the IP address is supplied from PDSN at all times, and thus the sequence of the procedure (m) is redundant.

Furthermore, since an incoming line speed is low in cdma 2000 1×EV-DO, it is required to reduce the information amount as much as possible. However, target sequences are carried out in the incoming and outgoing lines in PPP, and thus the efficiency is low.

### SUMMARY OF THE INVENTION

An object of the present invention is to provide a call setting method of a packet exchange network that can shorten a time needed for call setting by omitting redundant steps at the time of authentication in SIP call and deleting steps and the data amount with a PPP non-standard message, and further can continue a call setting step by a PPP standard step even when MS or PDSN is not adapted to the non-standard message.

In order to attain the above object, according to the present invention, a call setting method for establishing PPP connection between MS and PDSN in a network comprising a wireless access network for establishing a wireless link with MS and a network system containing PDSN (packet data exchange node) for connecting the wireless access network to a broad network, is characterized by comprising the following means.

(1) a step for establishing a wireless link between MS and PDSN, a step for transmitting a standard set request message from PDSN to MS, a step of transmitting a non-standard set request message from PDSN to MS, a step of responding to any one of the standard and non-standard set request messages and transmitting a standard or non-standard set response message, and a step of carrying out authentication of MS on the basis of the content of the standard or non-standard set response message by PDSN, wherein MS preferentially responds to the non-standard set request message in accordance with whether the MS is adapted to the non-standard message or not.

(2) The MS adapted to the non-standard message is characterized by containing a step of receiving a standard set request message and then waits for a predetermined time without responding to the message concerned, a step of transmitting a non-standard set response message in response to a non-standard set request message when receiving the non-standard set request message concerned within the waiting time, and a step of transmitting a standard set response message in response to the standard set request message when the non-standard set request message cannot be received within the waiting time.

(3) The non-standard message contains an option field in which plural set requests dispersively registered in plural standard messages are collectively registered, and the plural set requests are collectively transmitted by the non-standard message concerned.

(4) The non-standard message contains an option field in which the message type thereof and a representative value of option data are registered.

(5) The option field has an area of plural bits, and each message type and the representative value of the option data thereof are registered at a predetermined 1 bit.

(6) The non-standard set response message contains a domain field, a sub-domain field, an NAI-type field and a PAP/CHAP expansion field, the PDSN further contains a step of constructing a user name on the basis of each information registered in the Domain field, the Sub-domain, the NAI-type field and the PAP/CHAP expansion field, and the step of constructing the user name contains a step of setting as an authentication user name a user name registered in the PAP/CHAP of a reception message when the NAI-type is a first type, and a step of constructing an authentication user name on the basis of IMSI of MS, a domain name associated with the Domain information and a sub-domain name associated with the sub-domain information when the NAI-type is a second type.

(7) The step of constructing the user name further contains a step of setting IMSI of MS as the authentication user name when the NAI-type is a third type.

(1) According to the invention of claim 1, a standard set request message is also transmitted together with the non-standard set request message from the PDSN corresponding to the non-standard message. Accordingly, if MS is adapted to the non-standard message, it can transmit a non-standard set response message in response to the non-standard set request message. Furthermore, even when MS is not adapted to the non-standard message, it can transmit a standard set response message in response to a standard set request message.

(2) According to the invention of claim 2, even when MS adapted to the non-standard message receives a standard set request message from PDSN, it does not immediately respond but waits for a predetermined time. Only when MS cannot receive any non-standard set request message within this predetermined time, it transmits a standard set response message in response to the standard set request message. Accordingly, if PDSN is adapted to the non-standard message, it can preferentially respond to the message concerned with a non-standard message. However, even when PDSN is not adapted to the non-standard message, it can respond with a standard message.

(3) According to the invention of claim 3, plural set requests which are dispersively registered in plural standard messages are registered in a non-standard message and collectively transmitted, so that the number of messages required for call setting can be reduced.

(4) According to the invention of claim 4, option data which occupy several tens of bits in an expansion field of a standard message are registered as a representative value together with the message type thereof, and thus the data amount can be reduced by shortening the expansion field.

(5) According to the invention of claim 5, option data which occupy several tens of bits in the expansion field of a standard message can be represented on a non-standard message by 1 bit.

(6) According to the invention of claim 6 and 7, an authentication user name itself is transmitted from MS to PDSN, and only information required to construct the user name concerned at the PDSN side may be transmitted, so that the amount of information to be transmitted from MS to PDSN can be reduced.

### BRIEF DESCRIPTION OF THE DRAWINGS

FIG. 1 is a diagram showing a sequence when the present invention is applied at the time of authentication in SIP call;

FIG. 2 is a diagram showing a format of AltPPP (non-standard) message;

FIG. 3 is a diagram showing an example of the registration content of a Kind field;

FIG. 4 is a diagram showing an example of the registration content of a Domain field;

FIG. 5 is a diagram showing an example of the registration content of a Sub-domain field;

FIG. 6 is a diagram showing an example of the registration content of a Rcq-Options field;

FIG. 7 is a diagram showing a format of an expansion field;

FIG. 8 is a diagram showing an example of the registration content of a Protocol ID field;

FIG. 9 is a diagram showing an example of the registration content of a Code field;

FIG. 10 is a diagram showing an example of the registration content of a Type-X field;

FIG. 11 is a diagram showing a format of a PAP/CHAP expansion field;

FIG. 12 is a diagram showing an example of the registration content of the Protocol ID field of the PAP/CHAP expansion field;

FIG. 13 is a diagram showing an example of the registration content of the Code field of the PAP/CHAP expansion field;

FIG. 14 is a flowchart showing the construction of the user name in PDSN and an authentication method;

FIG. 15 is a diagram showing a sequence when only PDSN is adapted to the non-standard AltPPP message and MS is not adapted to the non-standard AltPPP message;

FIG. 16 is a diagram showing a sequence when only MS is adapted to the non-standard AltPPP message, and PDSN is not adapted to the non-standard AltPPP message;

FIG. 17 is a state transition diagram of MS and PDSN;

FIG. 18 is a diagram showing the network construction of a packet exchange network to which the present invention is applied;

FIG. 19 is a sequence diagram when CHAP is adopted at the time of authentication in SIP call.

### DETAILED DESCRIPTION OF THE PREFERRED EMBODIMENTS

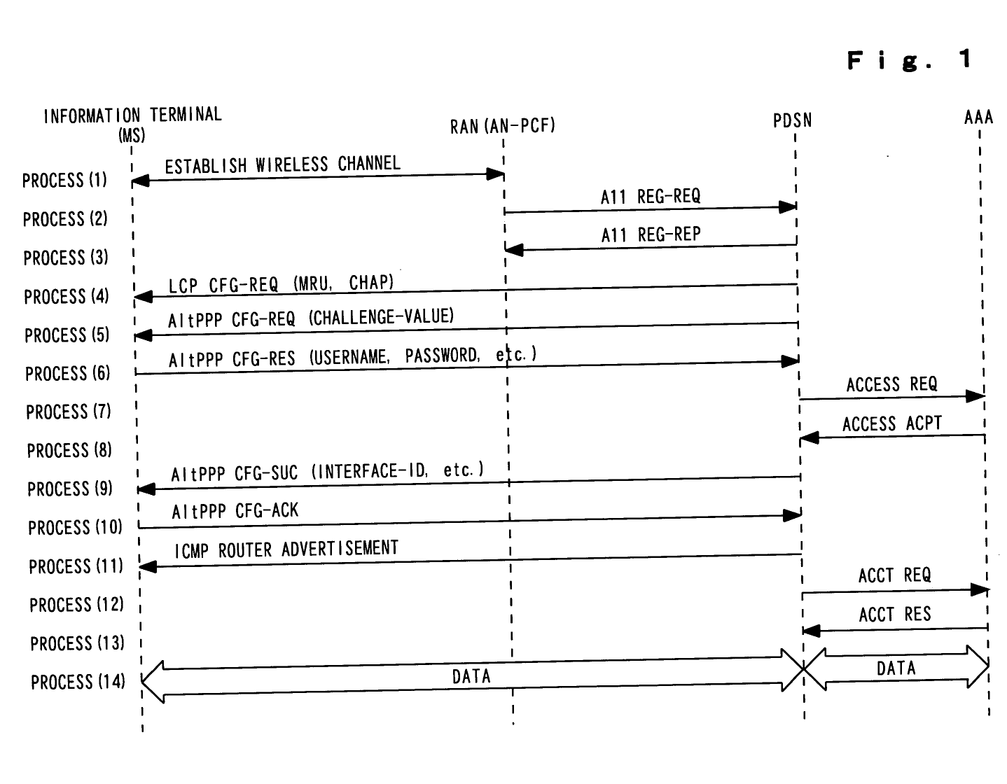

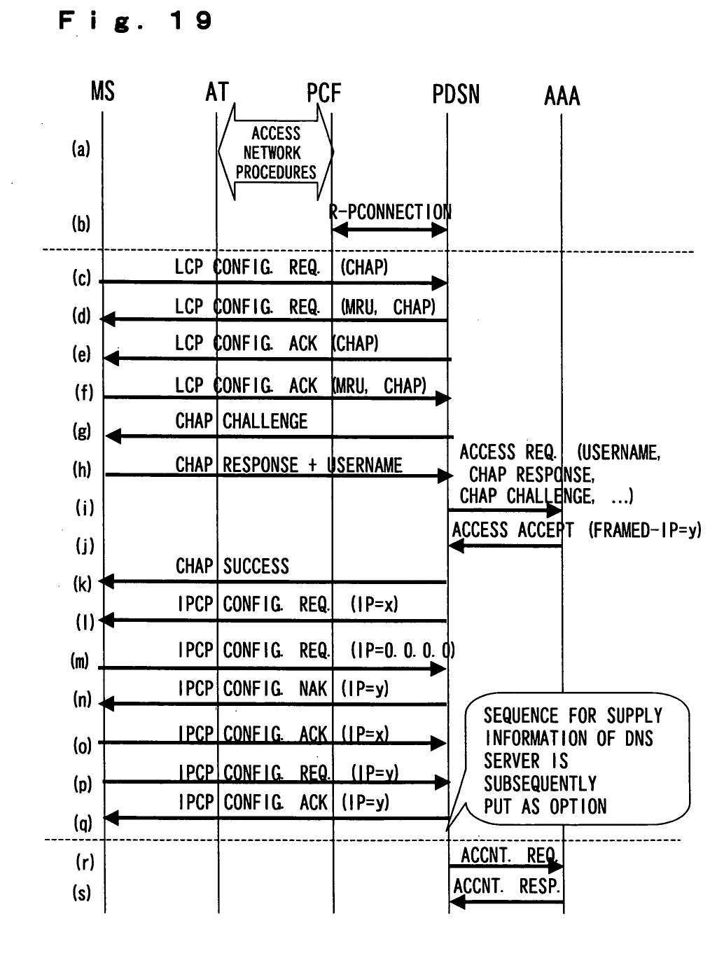

FIG. 1 is a diagram showing a sequence when the present invention is applied at the time of authentication in SIP call defined in cdma 2000 in the network system described with reference to FIG. 18, and FIG. 17 is a state transmission diagram.

Procedure (1): wireless channel is established between MS and RAN in Dead phase.

Procedure (2): after terminal authentication succeeds, All Registration Request is transmitted from PCF of RAN to PDSN.

Procedure (3): All Registration Reply of the procedure (2) is transmitted from PDSN to PCF. As a result, R-P connection (A10/11) is established between PCF and PDSN, and the state shifts to Establish Phase.

Procedure (4): in order to establish a wireless channel in the data link layer between PDSN and MS, PPP standard LCP (Link Control Protocol) Cfg-Request is transmitted in Initial Phase. This message contains CHAP-based authentication request and receivable maximum packet size MRU in PDSN.

Procedure (5): PPP non-standard Cfg-Request message inherent to the present invention is transmitted simultaneously with the LCP Cfg-Request from PDSN to MS. In this embodiment, a suffix “AltPPP” is added to a non-standard message in order to discriminate the non-standard message and the standard message from each other. The AltPPP Cfg-Request contains a cipher key (challenge value) used for CHAP authentication. When mounted, it is preferable that the LCP Cfg-Request of the procedure (4) and the AltPPP Cfg-Request of the procedure (5) are contained in the same A10 packet. Thereafter, PDSN shifts to Waiting Phase.

In this embodiment, in order to prevent reception leaks of a message in MS, the message concerned is re-sent by a predetermined number of times. At this time, ID, challenge value, etc., are set to be identical.

Procedure (6): In this embodiment, MS is adapted to the non-standard message, and thus PPP non-standard AltPPP Cfg-Response is transmitted from MS to PDSN in response to the AltPPP Cfg-Request message. This message contains “Domain field,” “Sub-domain field,” “NAI-type field” and “Extension field” described in detail later, and data for CHAP/PAP authentication are registered in the expansion field. Thereafter, MS shifts to the Proceeding phase.

Procedure (7): When receiving AltPPP Cfg-Response from MS, PDSN stops the re-sending of the AltPPP Cfg-Request, transmits a RADIUS access-Request message to an AAA (Accounting, Authentication, and Authorization) server and then shifts to Proceeding Phase.

At this time, when a condition for transmitting the RADIUS Access-Request is not satisfied, for example, when CHAP/Response or PAP/Request is not registered in AltPPP Cfg-Response received by PDSN and a password is not registered in PDSN in advance or the like, AltPPP Cfg-Nak is transmitted from PDSN to MS.

Procedure (8): RADIUS Access-Accept is transmitted from the AAA server to PDSN. This message contains an authentication result (success or failure) and an IP address used in MS as occasion demands.

Procedure (9): AltPPP Cfg-Success is transmitted from PDSN to MS. This message contains information of an IPv4 address, IPv6 Interface-ID, IPv4 DNS address, etc. Thereafter, PDSN shifts to Opening Phase.

Procedure (10): MS returns AltPPP Cfg-Ack to PDSN in response to reception of the AltPPP Cfg-Success, and then shifts to Opening Phase. At this time, MS starts services or transmits AltPPP Cfg-Nak while keeping the Proceeding phase.

PDSN receives AltPPP Cfg-Success and shifts to PPP network phase. Thereafter, services can be started according to the standard PPP. When an AltPPP Cfg-Nak message is received from MS, AltPPP Cfg-Success is transmitted while keeping the Opening phase. At this time, the corresponding option of the Configure-Request such as IPCP/IPv6CP or the like is set in conformity with the content of Nak, and the other parameters are set to the same as AltPPP Cfg-Success which was past transmitted.

Procedure (11): Router Advertisement is transmitted from PDSN to MS. This message contains IPv6 Prefix information and IPv6 DNS address information.

Procedure (12): RADIUS Accounting Request is transmitted from PDSN to AAA, and start of charging is requested.

Procedure (13): RADIUS Accounting Response is returned from AAA to PDSN, and start of charging is acknowledged.

Procedure (14): data communication is started between MS and PDSN.

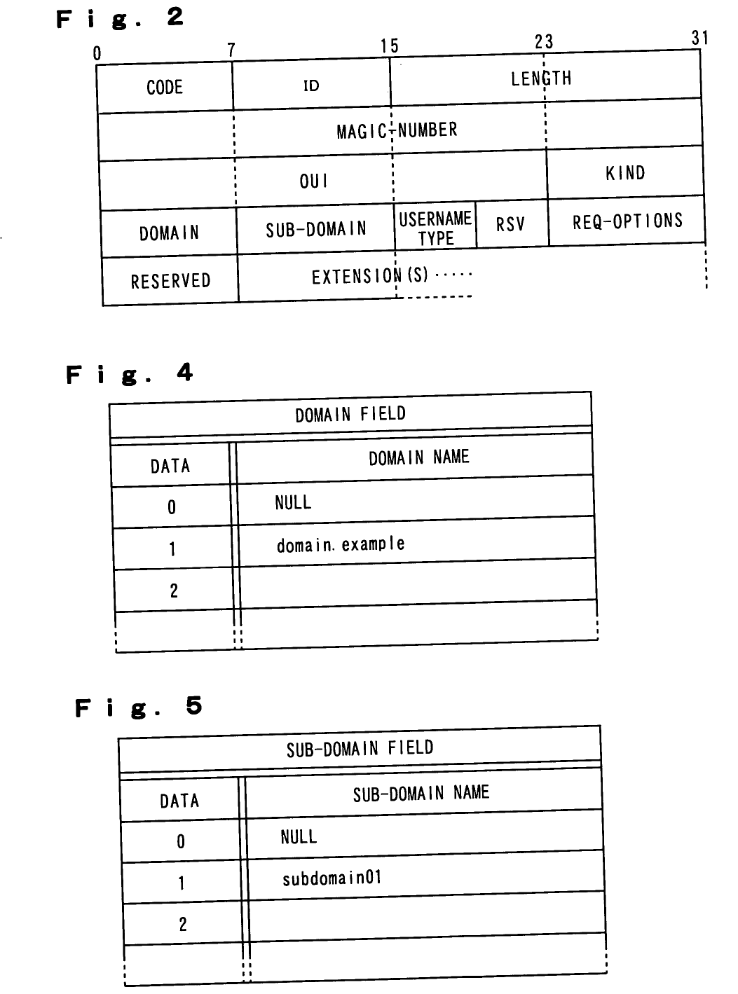

FIG. 2 is a diagram showing the format of the AltPPP message, and it contains a code field having the message type registered therein, an ID field having the identifier of a transmitter registered therein, a Length field having the length of the overall packet (Code-Extension) registered therein and an error detecting Magic-Number field as defined in RFC2153.

The AltPPP message further contains an OUI field in which the identifier of a vendor or a communication enterprise is registered, a Kind field in which the presence or absence of Extension and the type of message are registered, a Domain field in which a representative value for specifying a domain name is registered, a Sub-domain field in which a representative value for specifying a sub-domain name is registered, a NAI-type field in which a constructing rule of a domain name using a user name is registered, and a Req-Options field in which data representative of various kinds of set requests which has been hitherto dispersively transmitted in plural standard messages and option data occupying several bits in the expansion field of the standard message together with the message type thereof are registered. In this embodiment, the logical sum of the respective data is registered in the Req-Options field.

In the Kind field, when an expansion header exists in this embodiment, “1” is set to the uppermost bit thereof. Describing more specifically, as shown in an example of FIG. 3, if the Kind field is “1”, or “129,” it is Configure-Request transmitted from PDSN to MS and it is used to notify CHAP challenge value to MS or establish A10 connection to MS.

If the Kind field is “2” or “130,” it is Configure-Response transmitted from MS to PDSN, and it is used to notify information concerning a user name or password to PDSN or notify information (IPv4 address, etc.) which is desired to be notified from PDSN as an option request.

If the Kind field is “3” or “131,” it is Configure-Success transmitted from PDSN to MS, and it is used to notify necessary information (IPv4 address, etc.) to MS when services are permitted, or notify information (IPv4 address, etc.) used by PDSN as an option request.

If the Kind field is “4” or “132,” it is configure-Ack transmitted from MS to PDSN, and it is used to notify reception of the Configure-Success to PDSN.

If the Kind field is “5” or “133,” it is Configure-NaK transmitted from PDSN to MS. When the service is not permitted, it is used to notify this to MS, or when an option request from PDSN is not acceptable, it is used to notify the content of reject/nak to PDSN.

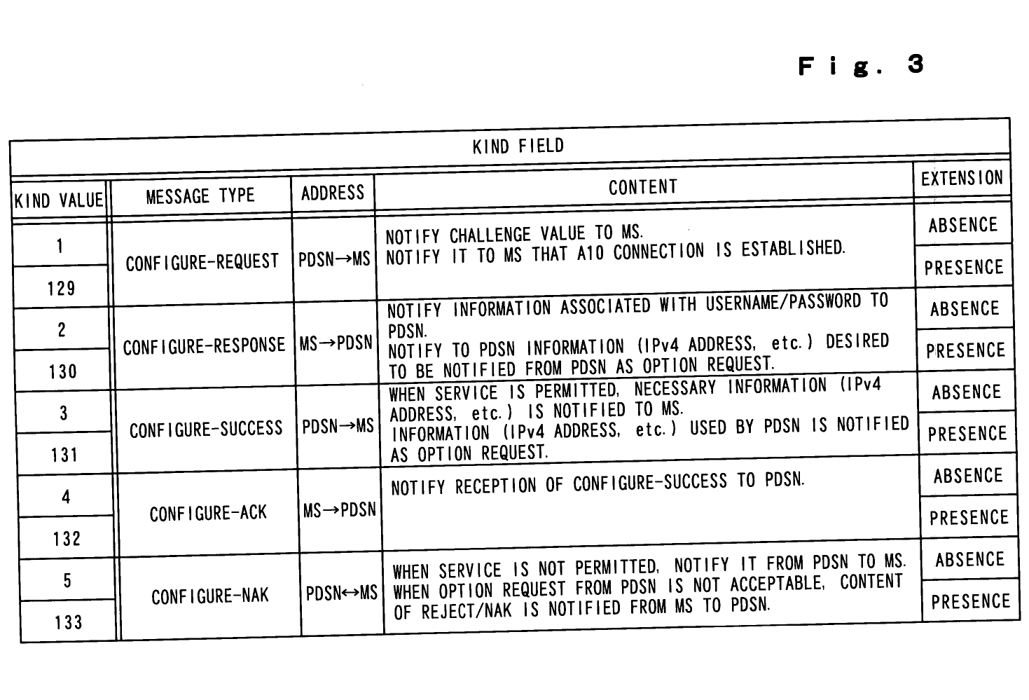

As shown in the example of FIG. 4, “0” is set in the Domain field when the user name is not set, and “1” is set in the Domain field when “domain.example” is indicated as a domain name. Likewise, with respect to domain names which are frequently used, “2,” “3,” . . . are registered as domain name representative values representative of domain names.

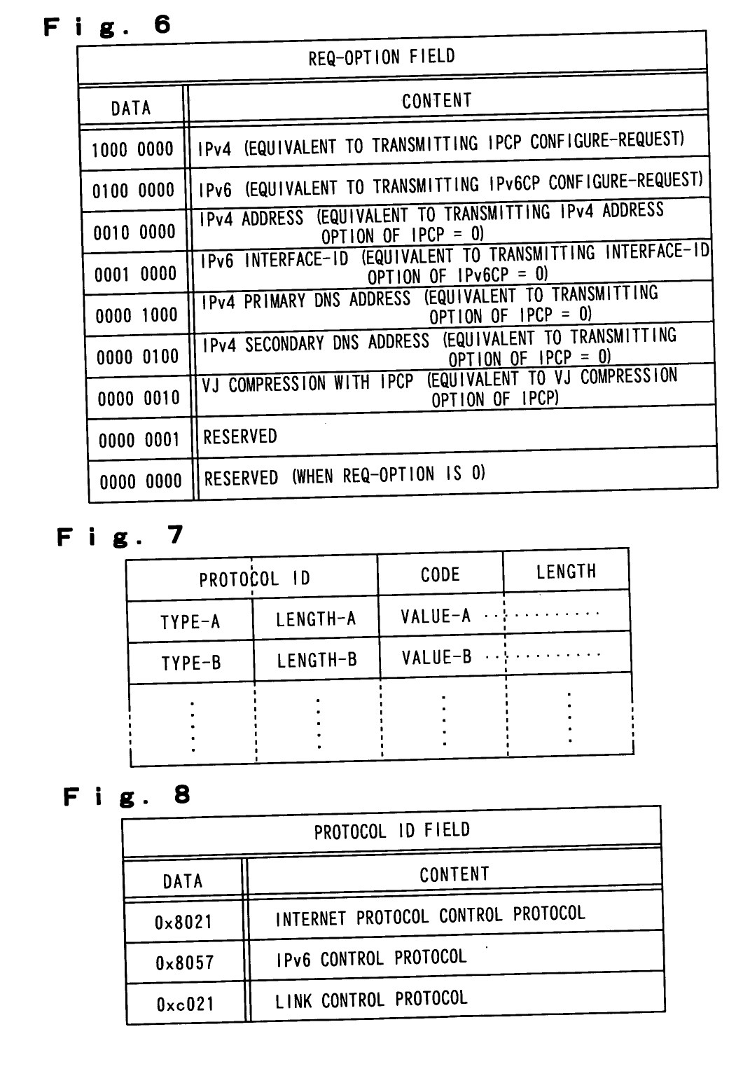

As shown in the example of FIG. 5, “0” is set in the Sub-Domain field when the user name or the Sub-domain is not set, and “1” is set in the Sub-domain field when “subdomain01” is set as a sub-domain name. Likewise, with respect to domain names which are frequently used, “2,” “3,” . . . are registered as sub-domain name representative values representative of sub-domain names.

As described later with reference to FIG. 14, “0” is registered in the NAI-type field when Username contained CHAP/Response or PAP/Request of an expansion field is set as a user name, “1” is registered in the NAI-type field when IMSI contained in the All message is set as a user name, and “2” is registered when IMSI@Sub-domain. Domain is set as a username. When the NAI-type is “1” or “2,” it is neglected even when Username is registered in the expansion field. The NAI-type, Domain and Subdomain are unique for every communication enterprises. Each communication enterprise is identified by country code and enterprise code.

Various kinds of set requests which have been hitherto transmitted while being dispersed in plural standard messages are collectively registered in the Req-Options field, and also each of option data occupying several tens of bits in the expansion field of the standard message and a value representative of the message type thereof is registered with 1 bit.

FIG. 6 shows the relationship between the state of each bit of the Req-Options field and the set content, and the set requests of IPv4 and IPv6 which have been transmitted while being dispersed into IPCP Cfg-Req and IPv6CP Cfg-Req can be performed by merely transmitting unique AltPPP Cfg-Req in which upper 2 bits of the Req-Options field are set. Accordingly, this embodiment can reduce the number of the call setting steps.

Furthermore, for example, in the procedure (m) of FIG. 19, when MS requests allocation of an IP address to PDSN, it is required to secure an option data field of 32 bits in the expansion field of IPCP Cfg-Req, register a dummy address “0.0.0.0” in the field concerned and transmit it.

In this embodiment, however, by transmitting AltPPP Cfg-Req in which an upper third bit of the Req-Options field is set, allocation of the IP address can be requested to PDSN without registering the dummy address in the expansion field concerned. Likewise, according to this embodiment, when MS requests the address of DNS to PDSN, by transmitting AltPPP Cfg-Req in which an upper fifth bit or sixth bit of the Req-Options field is set, the address of DNS can be requested to PDSN without registering the dummy address “0.0.0.0” of DSN in the expansion field, whereby the data mount can be reduced by shortening the expansion field.

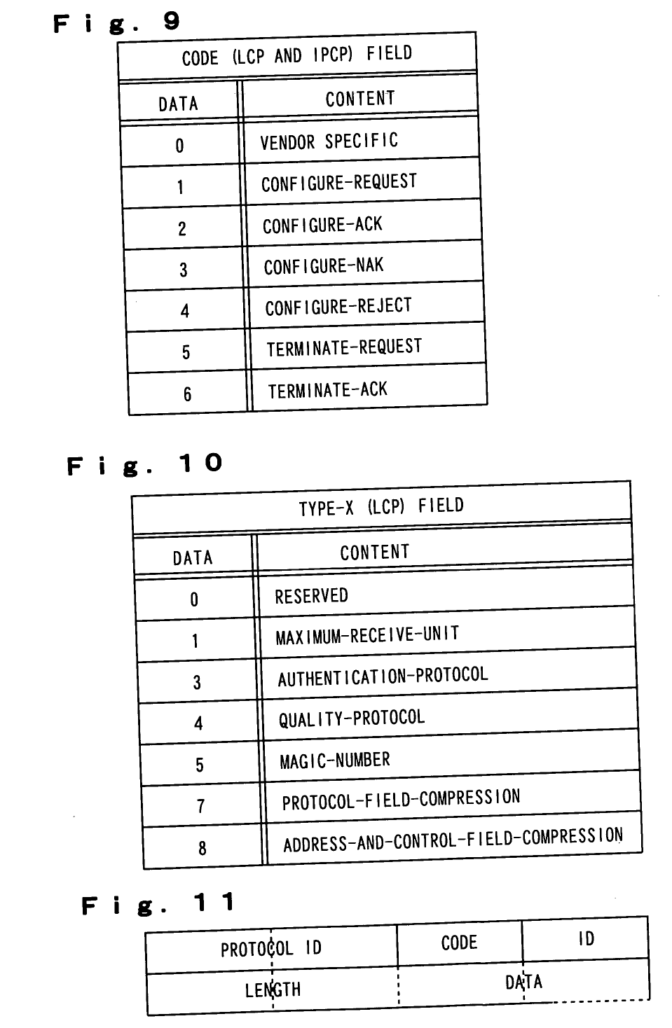

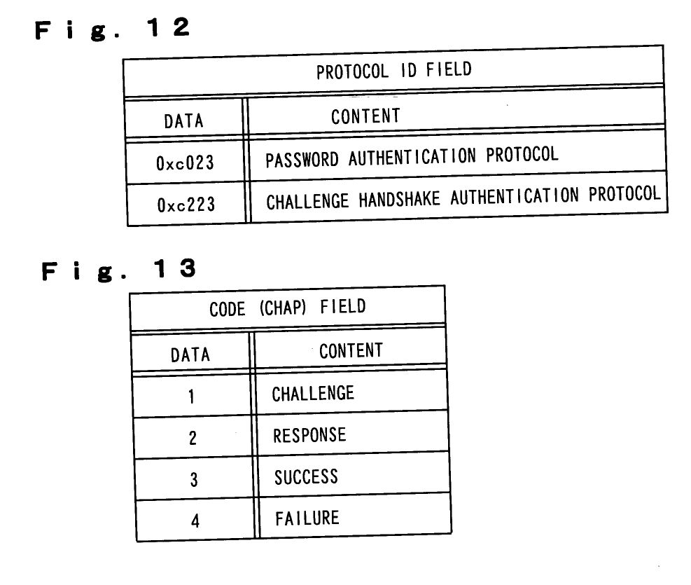

FIG. 7 shows the format of the expansion field in LCP/IPCP/IPv6CP, and as shown in an example of FIG. 8, DLL Protocol Numbers assigned in IANA is set in the Protocol ID field. As shown in the case of LCP and IPCP in FIG. 9, Code defined in LCP, IPCP or the like is set in the Code field. The number of bytes of the option parameter is set in the Length field as defined in LCP, IPCP or the like.

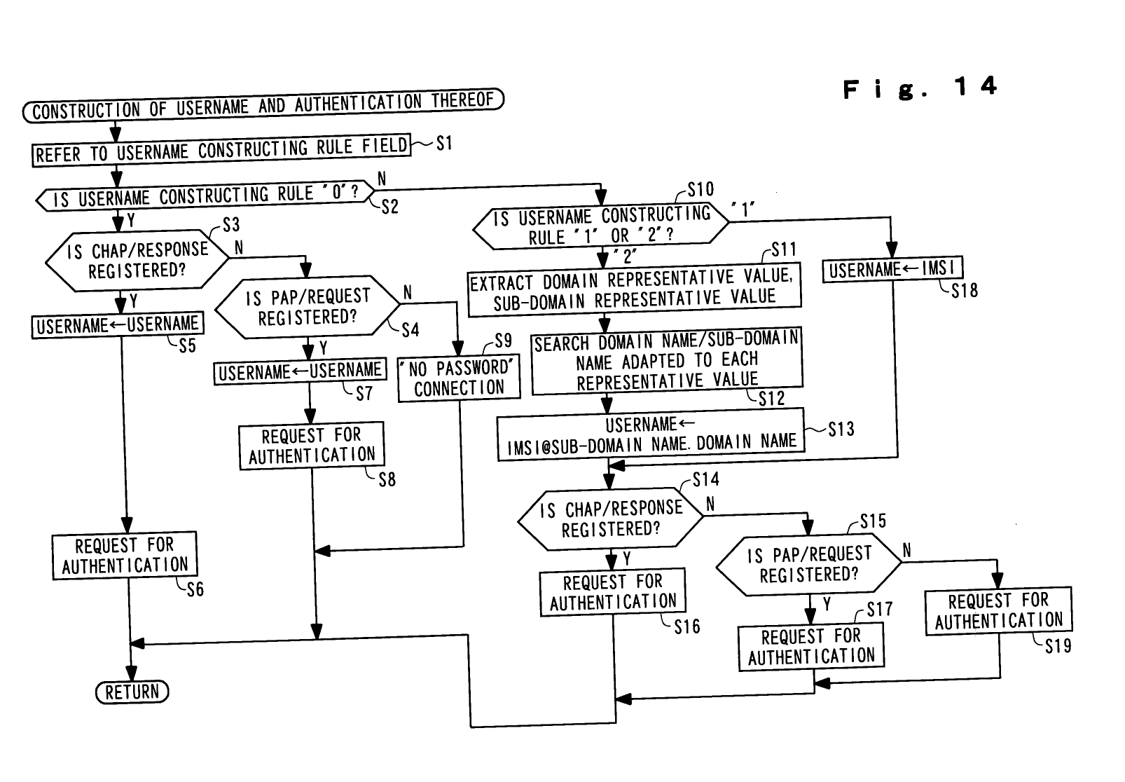

As shown in the case of LCP in FIG. 10, a value defined in LCP, IPCP or the like for the type of the option parameter is set in Type-X (X=A, B, . . . ) field. The byte number of the option parameter is set in the Length-X field as defined in LCP, IPCP or the like. Value defined in LCP, IPCP or the like for the option parameter is set in the Value-X field.

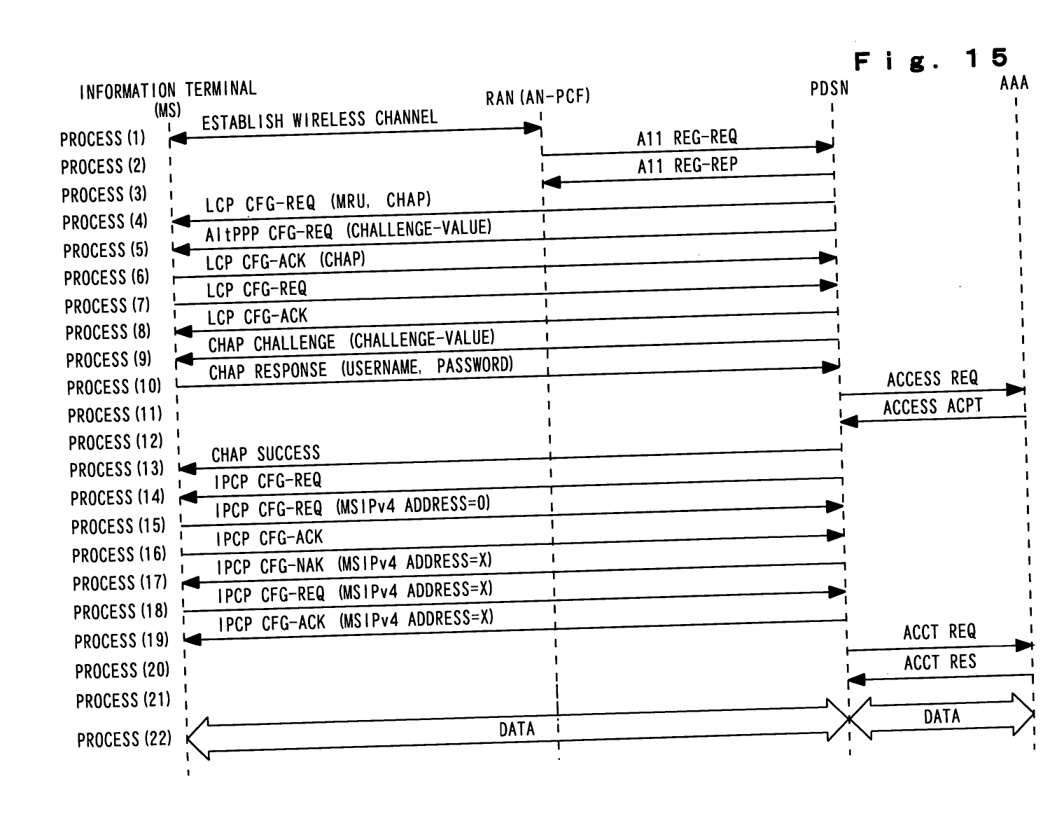

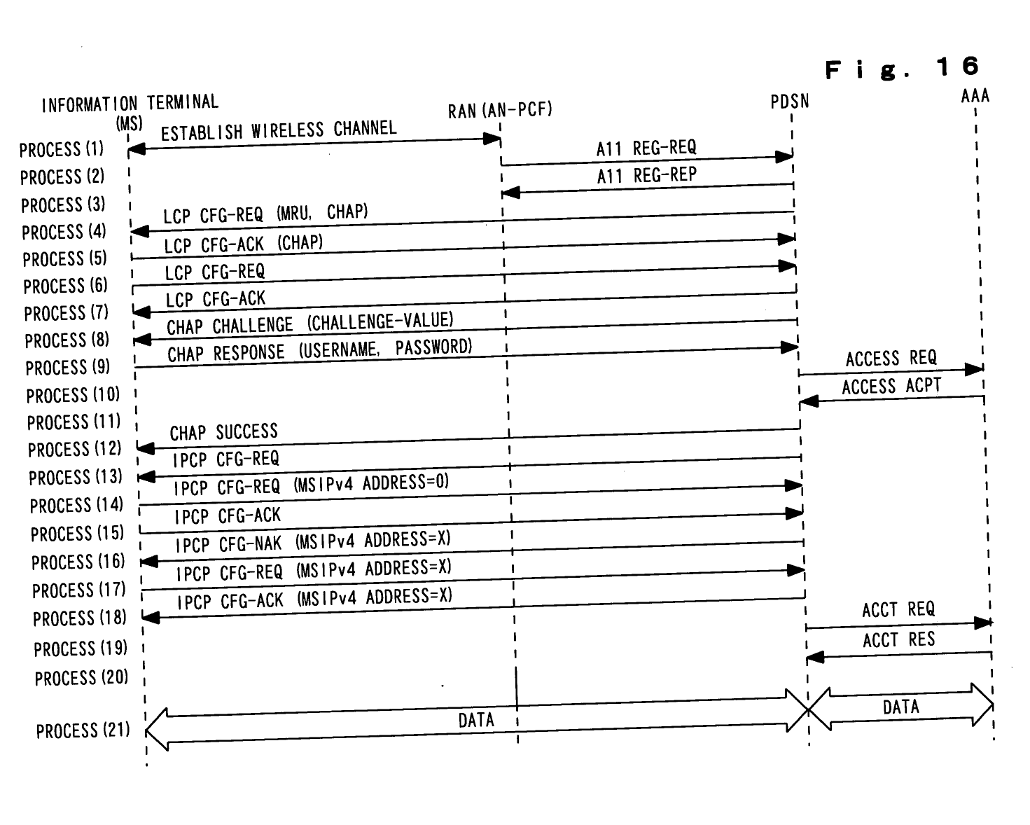

FIG. 11 is a diagram showing the format of the PAP/CHAP expansion field, DLL Protocol Numbers assigned in IANA are set in the Protocol ID field as shown in an example of FIG. 12. As shown in the case of CHAP in FIG. 13, Code defined in CHAP is set in the Code field. A value defined in PAP, CHAP or the like is set in the ID field. A value defined in PAP, CHAP or the like is set in the Length field. A value (containing Username) defined in PAP, CHAP or the like is set in the Data field.

Subsequently, a method for constructing the user name on the basis of the registered data of the AltPPP Cfg-Response received in the procedure (6) and authenticating it by PDSN will be described with reference to the flowchart of FIG. 14.

In this embodiment, the AltPPP Cfg-Response contains the Domain Field, the Sub-domain field, the NAI-type field and the PAP/CHAP expansion field, and PDSN receiving the AltPPP Cfg-Response constructs the user name according to the following procedure on the basis of the data registered in the Domain field, the Sub-domain field, the NAI-type field and the PAP/CHAP expansion field and requests the AAA server for authentication thereof.

In step S1, the NAI-type field of the AltPPP Cfg-response is referred to. In step S2, NAI-type is identified on the basis of the reference result. NAI-type defines a rule when PDSN constructs a user name for authentication on the basis of the data registered in each field, and if NAI-type is “0,” the processing goes to step S3. In steps S3 and S4, it is judged which one of CHAP/response and PAP/request is registered in the PAP/CHAP expansion field.

If the CHAP/response is registered in the PAP/CHAP expansion field, the processing goes to step S5 to register as an authentication user name the Username registered in the Data field of the CHAP/response expansion field. In step S6, the authentication user name constructed in step S5, the CHAP challenge value registered in the AltPPP Cfg-Request being transmitted to MS in the procedure (5) and the CHAP password registered in the Data field of the CHAP/response expansion field are transmitted to the AAA server in the procedure (7).

On the other hand, if the PAP/request is registered in the PAP/CHAP expansion field, the processing goes to step S7, and the Username registered in the Data field of the PAP/request expansion field is registered as an authentication user name. In step S8, the authentication user name constructed in step S7 and the user password registered in the Data field of the PAP/request expansion field are transmitted to the AAA server in the procedure (7). If neither CHAP/response nor PAP/request is registered in the PAP/CHAP expansion field, the processing goes to step S9 to set “no password” connection.

On the other hand, if it is judged in step S2 that NAI-type is judged other than “0,” the processing goes to step S10. In step S10, it is judged which one of “1” and “2” the NAI-type is. If NAI-type is “2,” the processing goes to step S11, and the Domain information registered in the Domain field of the AltPPP Cfg-response and the Sub-domain information registered in the Sub-domain field are extracted. In step S12, the domain name and the Sub-domain name which are associated with each representative value in advance are searched.

In step S13, “IMSI@sub-domain name.domain name” which is constructed by combining the IMSI contained in the All message and the domain name and the sub-domain name thus searched is registered as a user name. That is, as shown in the example of FIG. 4, if the Domain information is “1, ” the domain name is set to “domain.example,” and if the Sub-domain information is “1,” the sub-domain name is set to “subdomain01.” Accordingly, in this case, the user name is set to “IMSI@subdomain01. domain.example” In step S10, if NAI-type is judged as “1,” the processing goes to step S18, and the IMSI itself is registered as an authentication user name.

In steps S14 and S15, it is judged which one of CHAP/response and PAP/request is registered in the PAP/CHAP expansion field. If CHAP/response is registered, the processing goes to step S16, and the authentication user name constructed in step S13 or S18, the CHAP challenge value registered in the AltPPP Cfg-request transmitted to MS in the procedure (5), and the CHAP password registered in the Data field of the CHAP/response expansion field are transmitted to the AAA server in the procedure (7).

On the other hand, if PAP/request is registered in the PAP/CHAP expansion field, the processing goes to step S17, and the authentication user name constructed in step S13 or S18 and the user password registered in the Data field of the PAP/request expansion field are transmitted to the AAA server in the procedure (7).

If neither CHAP/response nor PAP/request is registered in the PAP/CHAP expansion field, the processing goes to step S19, CHAP calculation is carried out on the basis of a password (common in domain) which is preset every domain or sub-domain, and the CHAP password and the CHAP-Challenge value are transmitted to the AAA server in the procedure (7).

As described above, in this embodiment, only information necessary to construct the authentication user name at the PDSN side is transmitted without transmitting the user name concerned itself from MS to PDSN, so that the amount of information transmitted from MS to PDSN can be reduced.

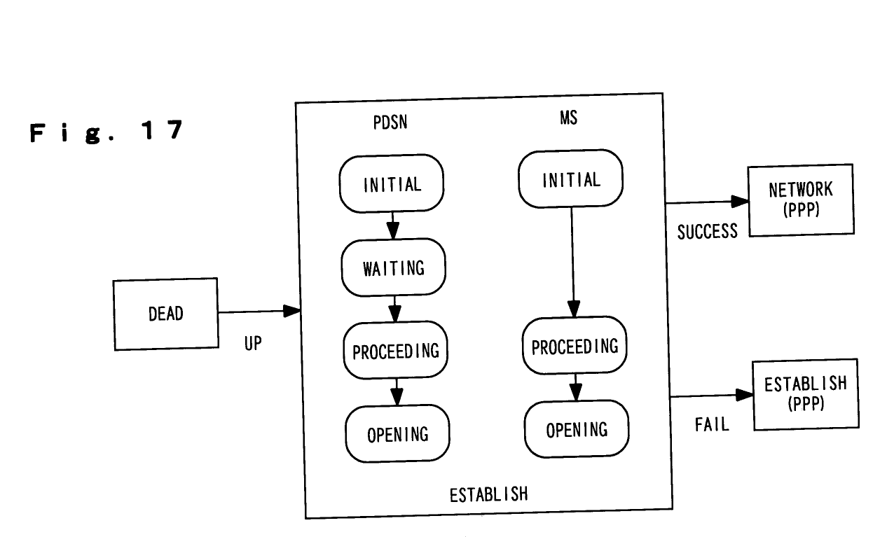

FIG. 15 is a diagram showing a sequence when only PDSN is adapted to the non-standard AltPPP message and MS is not adapted to the non-standard AltPPP message.

In MS, PPP standard LCP Cfg-Req is received in the procedure (4), and at the same time PPP non-standard AltPPP Cfg-Req is received in the procedure (5). In non-adapted MS, non-standard AltPPP Cfg-Req is neglected, and LCP Cfg-Ack is transmitted in the procedure 6) in response to standard LCP Cfg-Req. Subsequently, the conventional PPP standard sequence is executed.

As described above, in this embodiment, not only PPP non-standard AltPPP Cfg-Req, but also PPP standard LCP Cfg-Req are simultaneously transmitted from PDSN to MS, and thus even MS which is not adapted to non-standard message can reply to a request from PDSN. Subsequently, the PPP standard sequence is executed as in the case of the prior art, and thus communications can be performed between PDSN adapted to non-standard message and non-adapted MS.

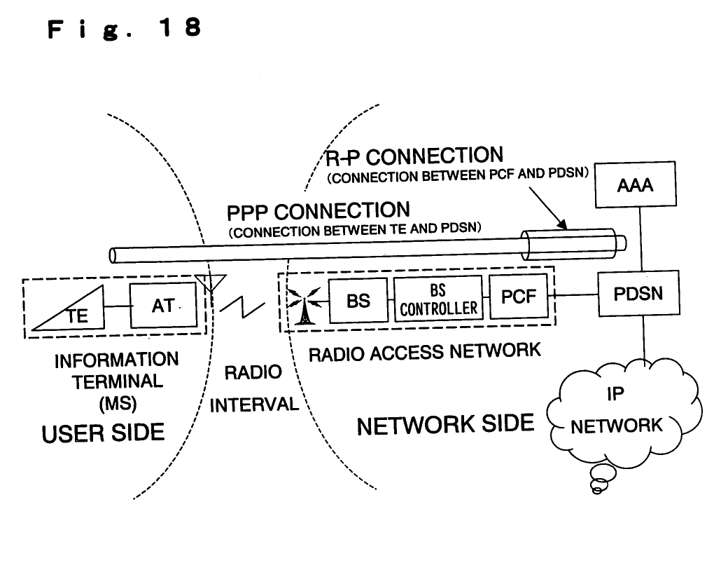

Contrary to the above, FIG. 16 is a diagram showing a sequence when only MS is adapted to non-standard AltPPP message and PDSN is not adapted to non-standard AltPPP message.

Even when MS receives PPP standard LCP Cfg-Req from PDSN in the procedure (4), MS does not immediately respond to it, and waits for a predetermined time to receive PPP non-standard AltPPP Cfg-Req. If MS receives AltPPP cfg-Req within this waiting time, MS returns PPP non-standard AltPPP Cfg-Res as in the case of the embodiment described with reference to FIG. 1.

On the other hand, when no AltPPP Cfg-Req is receivable and the waiting time elapses, in response to the PPP standard LCP Cfg-Req received in the procedure (4), LCP Cfg-Ack is transmitted in the procedure (5). Subsequently, the conventional PPP standard sequence is executed.

As described above, in this embodiment, even when MS receives PPP standard LCP Cfg-Req, MS does not immediately respond to it, and waits for a predetermined time to receive PPP non-standard AltPPP Cfg-Req. Even when MS cannot receive any AltPPP Cfg-Req after the waiting time elapses, the sequence shifts to the PPP standard sequence, and thus communications can be performed between MS adapted to non-standard message and non-adapted PDSN.

1. A call setting method for establishing PPP connection between a wireless terminal (mobile node) and PDSN in a network comprising the wireless terminal and a network system containing a wireless access network for establishing a wireless link with the wireless terminal and PDSN (packet data exchange node) for connecting the wireless access network to a broad network, comprising the steps of:
establishing a wireless link between the wireless terminal and PDSN;
transmitting a standard set request message from PDSN to the wireless terminal;
transmitting a non-standard set request message from PDSN to the wireless terminal;
transmitting standard or non-standard set response message in response to any one of the standard and non-standard set request messages by the wireless terminal; and
authenticating the wireless terminal on the basis of the content of the standard or non-standard set response message by PDSN, wherein
the wireless terminal preferentially responds to the non-standard set request message in accordance with whether the wireless terminal is adapted to the non-standard message or not.

2. The call setting method for the packet exchange network according to claim 1, wherein
the wireless terminal adapted to the non-standard message comprising the steps of:
waiting for a predetermined time without responding to the standard set request message after receiving the message concerned;
responding to a non-standard set request message when receiving the non-standard set request message concerned within the waiting time, and transmitting a non-standard set response message; and
responding to the standard set request message when non-standard set request message can be received within the waiting time, and transmitting a standard set response message.

3. The call setting method for the packet exchange network according to claim 1 or 2, wherein the non-standard message contains an option field in which plural set requests which are dispersively registered in plural standard messages are collectively registered, and the plural set requests are collectively transmitted by the non-standard message.

4. The call setting method for the packet exchange network according to claim 1 or 2, wherein the non-standard message contains an option field in which the message type thereof and a representative value of option data are registered.

5. The call setting method for the packet exchange network according to claim 4, wherein the option field has an area of plural bits, and each message type and the representative value of the option data thereof are registered with predetermined 1 bit.

6. The call setting method for the packet exchange network according to claim 1 or 2, wherein
the non-standard set response message contains a Domain field, a Sub-domain field, an NAI-type field and a PAP/CHAP expansion field,
PDSN further comprising a step of constructing a user name on the basis of information registered in the Domain field, the Sub-domain field, the NAI-type field and the PAP/CHAP expansion field, and
the step of constructing the user name contains
a step of setting as an authentication user name the user name registered in the PAP/CHAP expansion field of the reception message when NAI-type is a first type, and
a step of constructing an authentication user name on the basis of IMSI of the wireless terminal, a domain name associated with the Domain information and a sub-domain name associated with the Sub-domain information when NAI-type is a second type.

7. The call setting method for the packet exchange network according to claim 6, wherein
the step of constructing the user name further contains a step of setting IMSI of the wireless terminal as an authentication user name when NAI-type is a third type.
